(19) United States
(12) Patent Application Publication
(10) Pub. No.: US 2009/0263078 A1
(43) Pub. Date: Oct. 22, 2009

(54) Optical device

(75) Inventors: Kazuhiko Hosomi, Tachikawa (JP); Toshiki Sugawara, Kokubunji (JP); Yasunobu Matsuoka, Hachioji (JP); Hideo Arimoto, Kodaira (JP); Shinichi Saito, Kawasaki (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/385,736

(22) Filed: Apr. 17, 2009

(30) Foreign Application Priority Data
Apr. 21, 2008 (JP) 2008-109734

(51) Int. Cl. G02B 6/12

(52) U.S. Cl. 385/14

(57) ABSTRACT

Plural p-n junctions are formed in a waveguide such that they have junction interfaces in a normal direction to a surface of a substrate (to an extending direction of the substrate). Accordingly, a doping concentration changes in only a horizontal direction in the substrate, and it is possible to fabricate using the same processes as those for silicon electronic devices and to perform device fabricating at a low cost. Moreover, two or more junction interfaces are formed in the waveguide and thus an occupied area of the waveguide in a refractive index modulation region expands. Therefore, the efficiency of the refractive index modulation can be improved and a low-voltage operation is possible.

### CLAIM OF PRIORITY

The present application claims priority from Japanese patent application serial no. JP 2008-109734, filed on Apr. 21, 2008, the content of which is hereby incorporated by reference into this application.

### BACKGROUND OF THE INVENTION

1. Field of the Invention

The present invention relates to an optical device, and in particular, to a configuration of a light control device, such as an optical modulator, an optical switch, and an attenuator, using silicon for a component.

2. Description of the Related Art

A technique that is called silicon photonics has been currently in the spotlight. A concept of an optical device using, as a material, silicon, which can be easily obtained and is inexpensively processed, has been proposed from the past. However, an actual light emitting device or a light control device using silicon has been slowly developed due to the following reasons: silicon has extremely low luminous efficacy, difficulties in growing quantum well structures, etc. Further, a bottleneck situation of wiring lines of a silicon electronic device is under close scrutiny because it is a problem to be solved in the near future. One approach to solve the above problem is to use a light wiring technique using a silicon waveguide. Moreover, it came to be considered that silicon photonics is effective in taking advantages of highly developed micro-fabrication technology or mass production technology enabling mass, batch production to reduce the cost, size, and power consumption of optical devices.

In order to actually use silicon for a light control device, it is required to operate at high efficiency and at high speed, and in particular, to operate at an operation voltage of 2-3 V or less and at a modulation speed of 10 Gbps or more.

An operation mechanism of a light control device is generally, roughly divided into refractive index control and absorption coefficient control. However, it is difficult to obtain a great change in an absorption coefficient of silicon. For this reason, only refractive index control is used. A refractive index modulation type device needs a refractive index change of about 1×10⁻⁴. Examples of physical phenomena changing the refractive index of silicon include a thermo-optic effect, an electro-optic effect, and a carrier plasma effect. The thermo-optic effect is a phenomenon in which a refractive index changes depending on heat. However, a temperature change method may be difficult to operate at high speed and cause a crosstalk due to heat. For this reason, it is difficult to be applied to a device that aims at a high speed operation. Further, electro-optic effects of silicon include a light Kerr effect and an absorption edge movement. In order to obtain a refractive index change of about 1×10⁻⁴, a voltage of several tens of volts should be applied to a core layer having a thickness of several hundreds of nm. For this reason, it cannot be applied to a device which aims at a low voltage operation.

Meanwhile, the carrier plasma effect uses a refractive index change according to a change in an absorption coefficient due to carriers. A refractive index change based on that phenomenon is considered to have a comparatively large absolute amount and an increasable speed and is thus considered as a powerful refractive index modulation principle.

FIG. 2 shows an example of a refractive index modulation disclosed in “Nature”, vol. 435, page 325. As shown in a cross-sectional view of a waveguide of FIG. 2, a p-type region and an n-type region are disposed on the left side and right side of a silicon waveguide, respectively, so as to form a p-i-n structure on the silicon waveguide of an intrinsic layer. It operates on a principle that a voltage is applied between the p-type region and the n-type region so as to inject actual carriers to the waveguide, thereby causing a change in a refractive index. This conventional scheme has a plain principle and a simple structure. However, since the operation speed is dependent on a transit time of the carriers, an ultrafast operation of 10 Gbps or more is difficult.

FIG. 3 shows an example of a refractive index modulation disclosed in “Nature”, Vol. 427, page 615. In this example, a MOS (Metal-oxide semiconductor) effect is used to control a reflective index. A MOS-type modulation scheme does not inject actual carriers but effectively changes the carrier concentration by use of an electric field effect, etc. In this scheme, transit of actual carrier does not occur. Therefore, it is fundamentally suitable for a high speed operation as compared to the scheme shown in FIG. 3. However, since a region in which a carrier concentration changes is smaller than a sectional area of a waveguide, the efficiency of refractive index change is low.

FIG. 4 shows an example which uses a material other than silicon and a modulation principle applicable to silicon, disclosed in “IEEE photonic Technology Letters”, Vol. 17, page 567. In this example, III-V compound semiconductors are used as materials, and a multilayered structure is formed by epitaxial growth such that a p-n junction is formed in a cross section of a waveguide. A scheme for applying a reverse bias in order to change a width of a depletion layer formed in a p-n junction interface is used. This scheme can expect a high speed operation without being accompanied with the injection of actual carriers, as the MOS-type scheme. Moreover, since a refractive index modulation region is larger than that in the MOS-type scheme, the efficiency of refractive index modulation is good. A structure of this example in which a carrier concentration changes in a direction perpendicular to a substrate can be comparatively easily formed in a compound semiconductor. However, in order to form the structure with silicon, fabrication processes become complicated. Further, the processes have low affinity with the fabrication processes of electronic devices. Accordingly, they do not lead to a reduction in the cost and go against an original concept using a silicon waveguide.

### SUMMARY OF THE INVENTION

As described above, in the related art, it is difficult to satisfy high-speed performance, a low-voltage operation (high efficiency), and easy fabrication with respect to a silicon waveguide type refractive index modulation device at the same time.

In order to achieve the object, according to an aspect of the present invention, it is provided a silicon waveguide type optical device that can perform highly effective refractive index modulation and a high speed operation and can be fabricated using the same processes as those of silicon electronic devices.

A structure according to an exemplary embodiment of the present invention is shown in FIG. 1. FIG. 1 is a cross-sectional view of a silicon waveguide having a refractive index modulation function. In order to solve the above-mentioned problems, in this exemplary embodiment of the present invention, as shown in FIG. 1, an n-p-n doping profile is formed in a direction perpendicular to a surface of a substrate (in a normal direction to an extending direction of the surface of the substrate) such that a waveguide having double p-n junction interfaces is configured. Therefore, a doping concentration changes along only the horizontal direction with the substrate (that is, an extending direction of the substrate) and fabrication can be performed using the same processes as those of silicon electronic devices. In other words, individual layers are doped with necessary impurities to have n-, p-, and n-type conductivities.

Moreover, double junction interfaces are provided in a waveguide so as to increase an area of a refractive index modulation region occupied by the waveguide, thereby improving the efficiency of refractive index modulation.

FIG. 5 schematically shows a principle of a refractive index change according to an exemplary embodiment of the present invention with an illustration having one p-n junction interface. A depletion layer in which carriers do not exist is effectively at the p-n junction interface. The thickness of the depletion layer changes depending on an electric field applied to the p-n junction interface. If a reverse bias is applied to the junction interface, a depletion layer area increases as shown on the right side of FIG. 5. As a result, carriers of the increased depletion layer area are effectively reduced, which is accompanied with a refractive index increase. FIG. 6 shows a calculation result of the dependency of the thickness of the depletion layer formed at the p-n junction interface on the carrier concentration. FIG. 6 also shows a plot illustrating a case in which a reverse bias of 1V is applied. It is quantitatively shown in FIG. 6 that the depletion layer is expanded when a reverse bias is applied.

FIG. 7 schematically shows a refractive index change when double p-n junction interfaces are formed in a waveguide. A refractive index changes depending on the number of junction interfaces in the same way as shown in FIG. 6 (in case of one p-n junction) 8. However, if an occupied area of the waveguide in the refractive index modulation region increases, more effective refractive index modulation can be expected. FIG. 8 shows the relationship between an applied voltage and a change in an effective refractive index in an illustration of a silicon waveguide which has a width of 400 nm and in which both of the p-type and n-type doping concentrations for forming an p-n junction are 5×10¹⁷. When a change amount of a refractive index is calculated, Equation 1 is used to calculate a change in an effective refractive index.

Δn_{eff}=Δn·ΔD/W [Equation 1]

Here, ΔD(delta D) represents a change amount of the thickness of the depletion layer, W represents the width of the waveguide, and ΔD/W represents an amount corresponding to a so-called F(gamma) factor. Accordingly, Δn_{eff} represents an amount indicating an averaged refractive index change in the waveguide. As for a refractive index change regarding a change in an amount of carriers, the following Equation 2 is used.

$$Δ n = \frac{- {e}^{2} {λ}_{0}^{2}}{8 {π}^{2} {c}^{2} {ɛ}_{0} n} ( \frac{{N}_{e}}{{m}_{ce}^{*}} + \frac{{N}_{h}}{{m}_{* ch}^{*}} ) \qquad [ Equation 2 ]$$

It can be seen from FIG. 8 that as a carrier concentration becomes higher, the change amount of the refractive index increases. As shown in FIG. 6, if the carrier concentration is high, the change of the depletion layer is small. Compared to this, the effect is stronger when an increase in the refractive index changes due to an increase in the change amount of the carrier concentration. In FIG. 8, a refractive index change in a case of a single junction interface is compared with a refractive index change in a case of double junction interfaces. The following can be seen from FIG. 8. In the case of the single junction interface, a refractive index change of 1×10⁻⁴ is obtained at 1.7 V and thus a low-voltage operation is possible. In contrast, in the case of the double junction interfaces, a refractive index change of 1×10⁻⁴ is obtained at 0.75 V which is less than half of 1.7 V and thus a further lower voltage operation is possible.

According to an exemplary embodiment of the present invention, it is possible to provide a silicon electronic device which can perform highly effective refractive index modulation and a high speed operation.

### BRIEF DESCRIPTION OF THE DRAWINGS

FIG. 1 is a cross-sectional view of a refractive index modulation structure of a silicon waveguide according to a first embodiment of the present invention;

FIG. 2 shows a first example of a refractive index modulation structure of a silicon waveguide according to the related art;

FIG. 3 shows a second example of the refractive index modulation structure of the silicon waveguide according to the related art;

FIG. 4 shows an example of a refractive index modulation structure of a waveguide using a compound semiconductor as a material;

FIG. 5 is a view schematically illustrating a change in a refractive index of a waveguide when an electric field is applied to a p-n junction formed in the waveguide;

FIG. 6 is a view illustrating the relationship between a thickness of a depletion layer formed at a p-n junction interface and a carrier concentration;

FIG. 7 is a view schematically illustrating a change in a refractive index of a waveguide when an electric field is applied to an n-p-n junction formed in the waveguide;

FIG. 8 is a view illustrating the dependency of an effective refractive index on an applied voltage when an electric field is applied to a p-n junction formed in a waveguide;

FIGS. 9A and 9B are cross-sectional views of a refractive index modulation structure of a silicon waveguide according to a second embodiment of the present invention;

FIG. 10 is a conceptual diagram of an MZ (Mach-Zehnder) interferometer according to a third embodiment of the present invention;

FIG. 11 is a conceptual diagram of a silicon ring resonator according to a fourth embodiment of the present invention;

FIG. 12 is a view illustrating the relationship between a loss and a wavelength in the silicon ring resonator according to the fourth embodiment of the present invention;

FIG. 13 is a view illustrating a multistage structure of a variable dispersion compensator using silicon ring resonators according to the fourth embodiment of the present invention;

FIG. 14 is a view illustrating the characteristic of a variable dispersion compensator using silicon ring resonators according to an exemplary embodiment of the present invention;

FIGS. 15A to 15C are views illustrating a structure of a silicon directional coupler and a waveguide constituting the silicon directional coupler according to a fifth embodiment of the present invention; and

FIG. 16 is a conceptual diagram of an asymmetrical MZ interferometer using a silicon ring resonator according to a sixth embodiment of the present invention.

### DETAILED DESCRIPTION OF THE PREFERRED EMBODIMENTS

Hereinafter, an exemplary embodiment of the present invention will be described in detail.

### First Embodiment

### First Vertical Junction Type

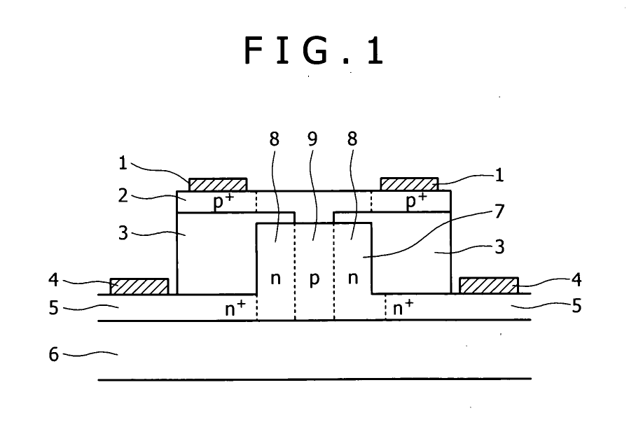

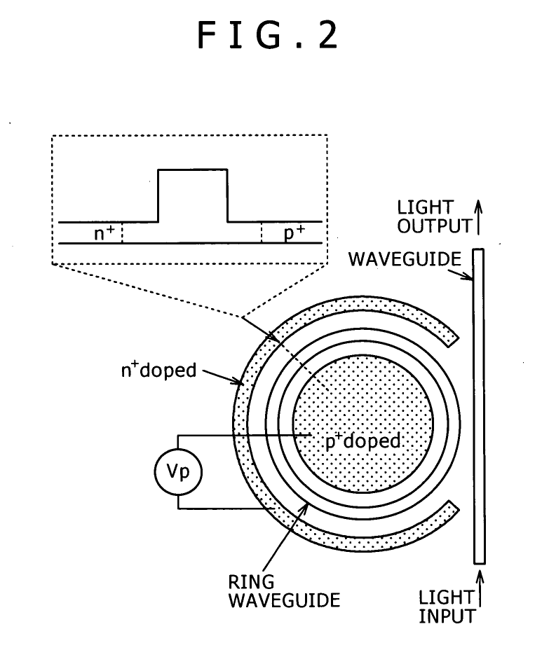

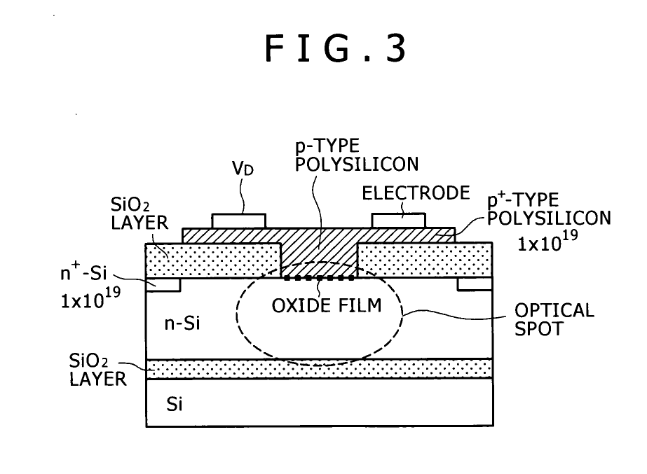

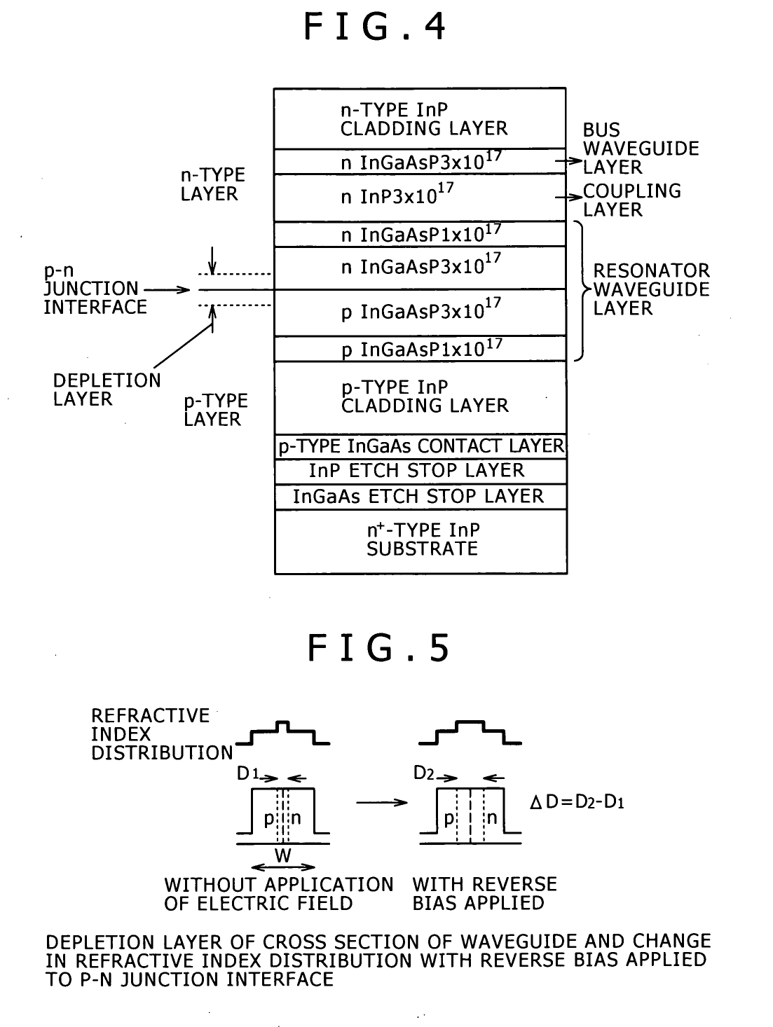

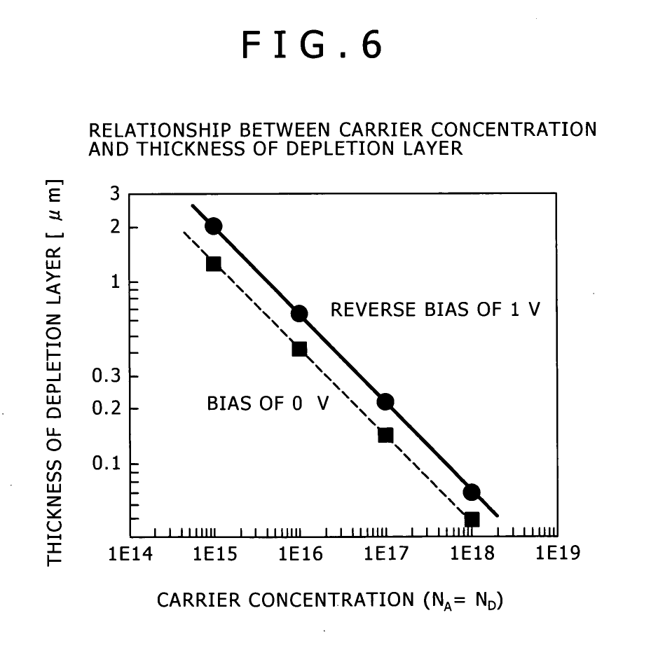

FIG. 1 shows a cross-sectional view of a waveguide constituting an optical device according to a first embodiment of the present invention. A silicon waveguide 7 has a width of 400 nm and a thickness of 200 nm, and serves as a single mode waveguide with respect to light in a communication wavelength range. An n-p-n junction is formed in the waveguide. All of the doping concentrations of an n-type layer 8 and a p-type layer 9 of the waveguide are controlled to 5×10¹⁷. The waveguide is formed of silicon or is formed by using silicon as a main constituent. Since an n-type part and a p-type part are parts having been doped with impurities, the waveguide can be considered as an example using silicon as a main constituent. The n-type layer 8 of the waveguide is electrically connected to N electrodes through n⁺-type layers 5 on the left and right sides of the waveguide, respectively. The whole waveguide is covered with a SiO₂ layer 3, and a p-type polysilicon layer 2 is formed immediately above the SiO₂ layer 3. As shown in FIG. 1, the polysilicon layer is configured to partially penetrate the SiO₂ layer 3 such that the polysilicon layer is electrically connected to only the p-type layer 9 of the waveguide. P electrodes 1 are formed on the polysilicon layer aside from a portion immediately above the waveguide. The doping concentrations of an n⁺-type layer 5 and a p⁺-type layer 2 shown in FIG. 1 are controlled to 1×10¹⁹.

Processes of fabricating this structure will be described. A waveguide having a width of 400 nm is formed on a substrate composed of an SOI layer and a BOX layer by lithography and dry etching techniques. The SOI layer has a thickness of 200 nm and the BOX layer has a thickness of 1 μm. Then, a portion of the SOI layer, other than a portion to be a waveguide, is etched to 50 nm, not completely. Next, carriers are doped by ion implantation. To this end, a mask is formed by lithography and ion implantation is performed on only desired regions, so as to form a p-n-p junction in the waveguide. Subsequently, a SiO₂ layer is formed by CVD so as to cover the waveguide region, and then unnecessary portions of the SiO₂ layer are removed. Next, a polysilicon layer is formed on only the waveguide. Finally, N electrodes and P electrodes are formed. Parts, which have not been particularly described, may be formed by standard deposition, lithography, and dry etching processes.

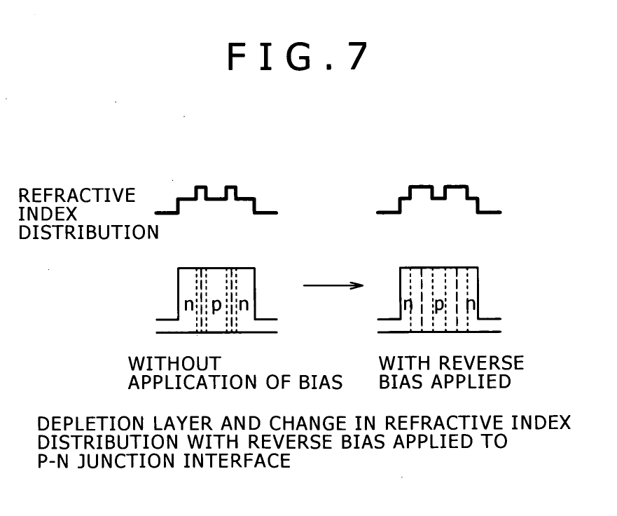

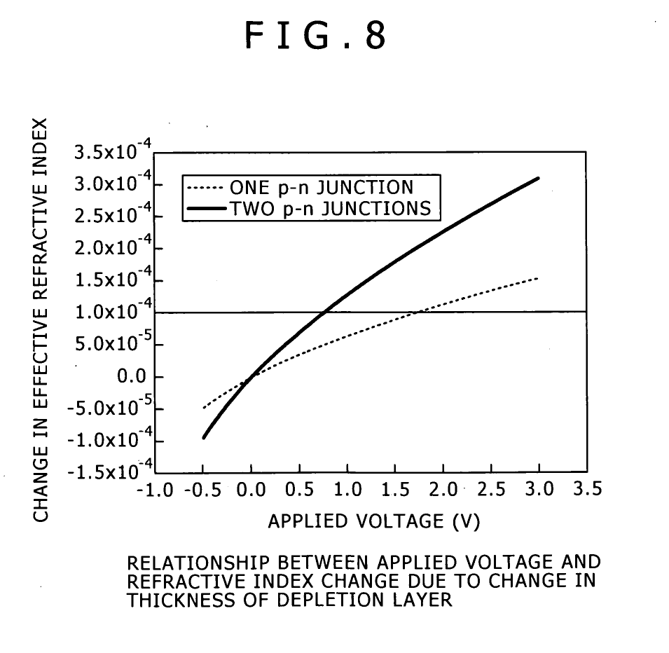

Next, an operation of the first embodiment will be described. In the first embodiment, a reverse bias is applied between the P electrodes 1 and the N electrodes 2 so as to apply an electric field to the waveguide. A change in a refractive index at that time is as schematically shown in FIG. 7. The application of the reverse bias expands the depletion layer, resulting in a change in a carrier concentration. This change in the carrier concentration causes a change in a refractive index. FIG. 8 shows the dependency of the refractive index change amount on the applied voltage according to the first embodiment. In FIG. 8, it is seen that the refractive index change of 1×10⁻⁴ is obtained at 0.75V and thus a low-voltage operation is possible.

### Second Embodiment

### Second Vertical Junction Type

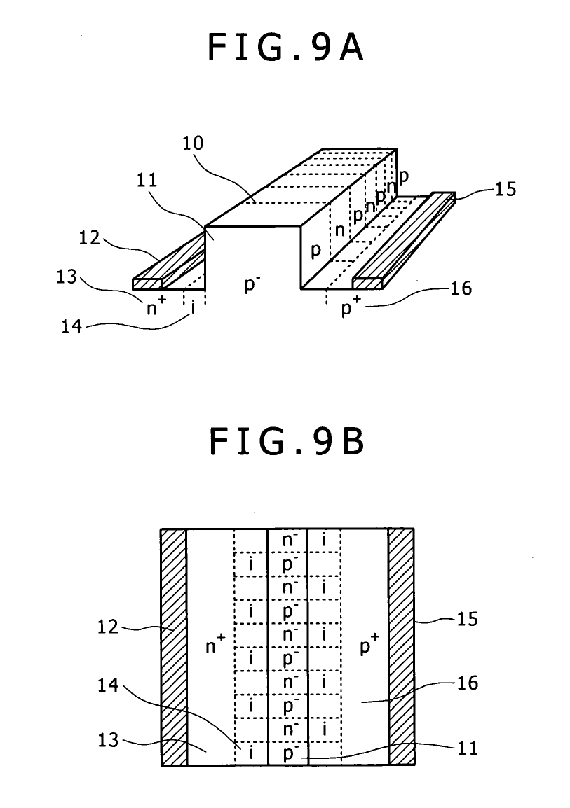

FIGS. 9A and 9B show cross-section views of a waveguide constituting an optical device according to a second embodiment of the present invention. FIGS. 9A and 9B are an overhead view and a top view of the waveguide according to the second embodiment, respectively. As shown in FIGS. 9A and 9B, in the second embodiment, p-n junction interfaces 10 are formed in parallel with a section of the waveguide. A p-type layer 11 of the waveguide is electrically connected to a P electrode through a p⁺-type layer 16 on a side of the waveguide. On the other hand, the p-type layer 11 and an n⁺-type layer 13 are completely electrically isolated from each other by an insulating layer 14. Similarly, an n-type layer of the waveguide is electrically connected to an N electrode 12 and is insulated from the p⁺-type layer 16 on the side of the waveguide.

Next, an operation of the second embodiment will be described. In the second embodiment, if a reverse bias is applied between the P electrode 15 and the N electrode 16, a thickness of a depletion layer of each of multiple p-n junctions formed in the waveguide increases. A direction of the change in the thickness of the depletion layer at that time becomes a direction following light propagation. The change in the thickness of the depletion layer causes a change in a carrier concentration, and a change in the refractive index is similar to the procedure described in the first embodiment.

### Third Embodiment

FIG. 10 shows an example of an MZ interferometer using a waveguide described in the first embodiment, according to a third embodiment of the present invention. Light introduced from a light entrance 23 is divided into two light components at a bifurcation and is guided to phase modulation units 24. Each phase modulation unit 24 is formed with the refractive index modulation structure described in the first embodiment. A voltage applied between a P electrode 22 and an N electrode 23 is changed to change the optical path lengths of upper and lower arms. A phase difference between the upper and lower arms is caused in response to an applied voltage, resulting in a change in the intensity of the light from an exit 23. The MZ interferometer according to the third embodiment is applicable to, for example, a light intensity modulator.

### Fourth Embodiment

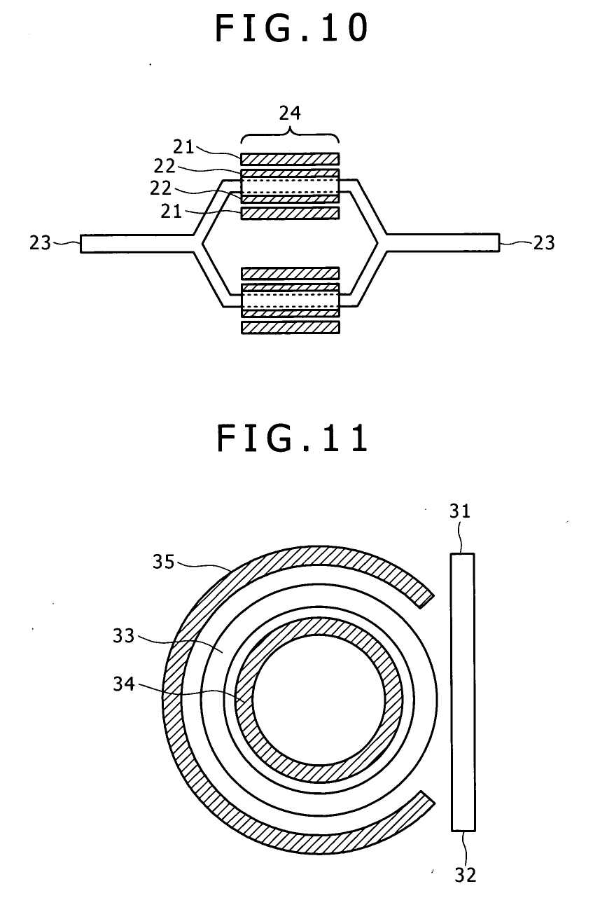

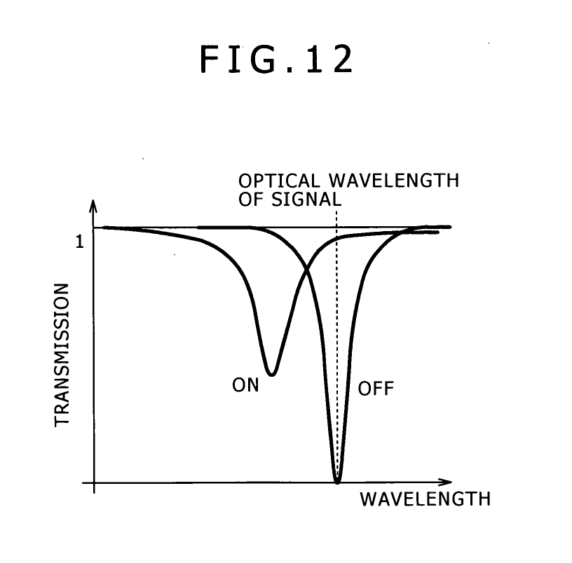

FIG. 11 shows an example of a silicon ring resonator using a waveguide according to the second embodiment, according to a fourth embodiment of the present invention. In the ring resonator shown in FIG. 11, the transmission of a light component of light introduced from an entrance 31 having a specific wavelength (resonant wavelength) determined by a light path length in a ring 33 is remarkably reduced. If a reverse bias is applied to the waveguide through an N electrode 34 and a P electrode 35, the refractive index of the waveguide increases and the light path length of the ring increases. Due to this increase in the light path length, the resonant wavelength is shifted. The shifting of the resonant wavelength is applicable to a light intensity modulator or a variable dispersion compensator. FIG. 12 shows the relationship between the wavelength and a loss in the ring resonator. Referring to FIG. 12, a principle of an operation of the light intensity modulator according to the fourth embodiment of the present invention will be described. In general, if there is no propagation loss of the waveguide, such a ring resonator has an APF (All Pass Filter) characteristic, that is, a characteristic in which all wavelengths are transmitted at a uniform rate.

However, actually, a waveguide has a loss. Therefore, a waveguide has a BRF (Band Rejection Filter) characteristic in which a loss becomes large at a certain wavelength due to a round trip loss caused in making a round in a ring resonator. It is possible to use the loss peak to realize a light intensity modulator. First, a voltage is set to a value at which the loss peak becomes sharpest (since a refractive index and an absorption coefficient also change). An optical wavelength of a signal is set to correspond to the loss peak at that time. Then, in that state, since the optical wavelength of the signal rarely transmits the ring resonator, the signal is considered in an OFF state. Next, an electric field is changed to match it with a wavelength, which a filter passes, thereby realizing a modulation state of a mark “ON.” In this way, it is possible to realize the light intensity modulator according to the fourth embodiment of the present invention. Moreover, it is possible to use that characteristic to gradually change voltages of the above-mentioned ON and OFF states, thereby realizing a variable light attenuator.

Next, a principle of an operation of a variable dispersion compensator will be described. Dispersion compensation is a technique of disposing an optical device, which has a wavelength dispersion characteristic inverse to that of an optical fiber used for a transmission path, in an optical transmitter, receiver, or repeater, so as to offset a wavelength dispersion characteristic of the optical fiber and prevent degradation of the waveform.

In the above-mentioned ring resonator, transmission is performed uniformly with respect to wavelengths. Accordingly, it is called as an all pass filter. However, it has wavelength dependency with respect to a phase (group delay time). Then, the group delay time τ is expressed by the following Equation 3.

$$τ = - \frac{2 r Δ L ( r + cos ω Δ L )}{1 + {r}^{2} + 2 r cos ω Δ L} \qquad [ Equation 3 ]$$

Here, r represents a parameter determined from a branching ratio, ω(omega) represents the angular frequency of light, and ωL represents an optical distance caused in making around in the ring resonator. A wavelength dispersion β (beta) is obtained by differentiating the group delay time with a wavelength, as expressed by Equation 4.

$$β = \frac{d τ}{d λ} \qquad [ Equation 4 ]$$

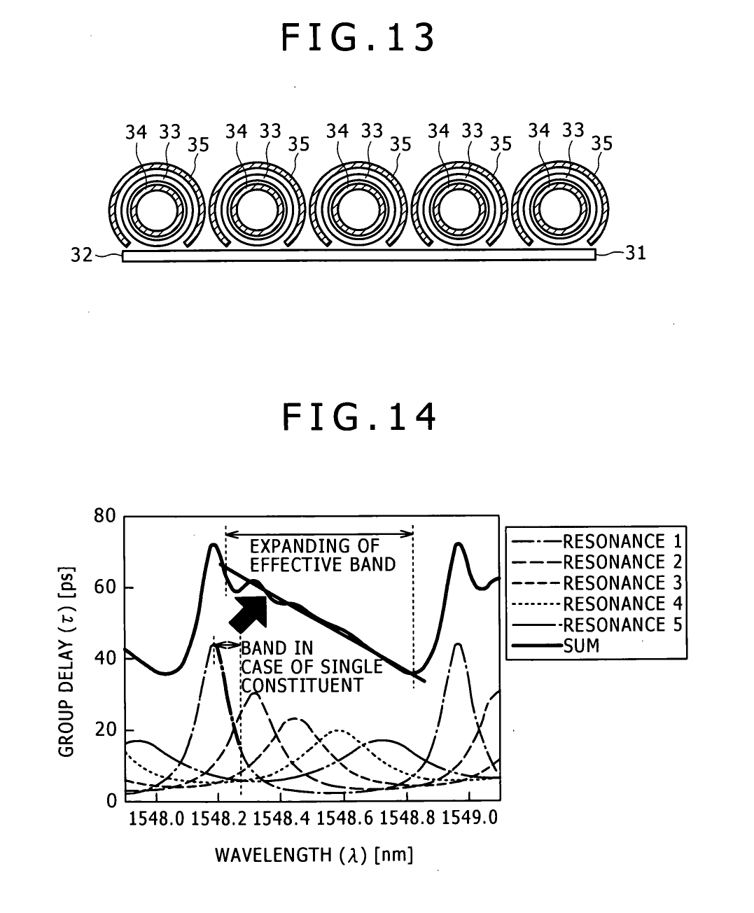

A high speed signal is strongly influenced by the wavelength dispersion. Accordingly, a dispersion compensator requires a broadband property. In realizing a variable dispersion compensator having the broadband property, a scheme of connecting multiple ring resonators according to the fourth embodiment of the present invention as shown in FIG. 13 is effective. FIG. 14 shows the group delay characteristic when five ring resonators are connected, which is obtained by Equation 3. It is possible to realize a variable dispersion compensator having the broadband property by controlling r and ωL in the ring resonators according to the fourth embodiment of the present invention.

### Fifth Embodiment

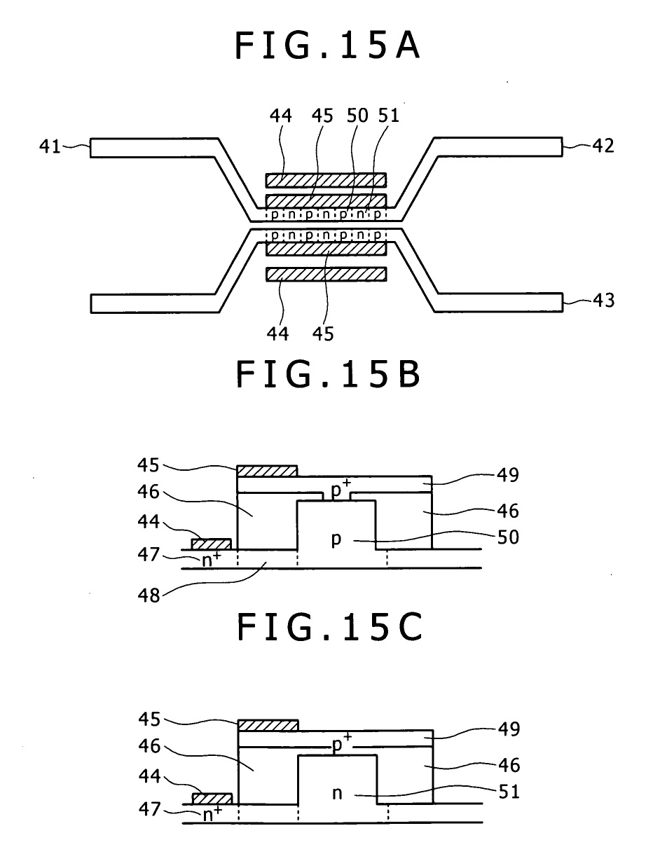

FIGS. 15A to 15C show an example of a silicon directional coupler using a waveguide according to the second embodiment, according to a fifth embodiment of the present invention. FIG. 15B is a view illustrating a cross section of a p-type region of the waveguide and FIG. 15C is a view illustrating a cross section of an n-type region of the waveguide. As shown in FIGS. 15B and 15C, the wave guide is buried in a SiO₂ layer 46. As shown in FIG. 15B, a p-type region 50 is electrically connected to a P electrode 45 through a p⁺-type polysilicon layer 49. On the other hand, a p-type region 51 is electrically connected to an N electrode 44 through an n⁺-type layer 47 on one side of the waveguide.

Light introduced from an entrance 41 is taken out from a first exit 42 and a second exit 43. The distribution of the intensity of light taken out from the first exit 42 and the second exit 43 can be controlled by controlling an electric field applied to the N electrode 44 and the P electrode 45. The directional coupler according to the fifth embodiment is applicable to, for example, a light intensity modulator or an optical switch.

### Sixth Embodiment

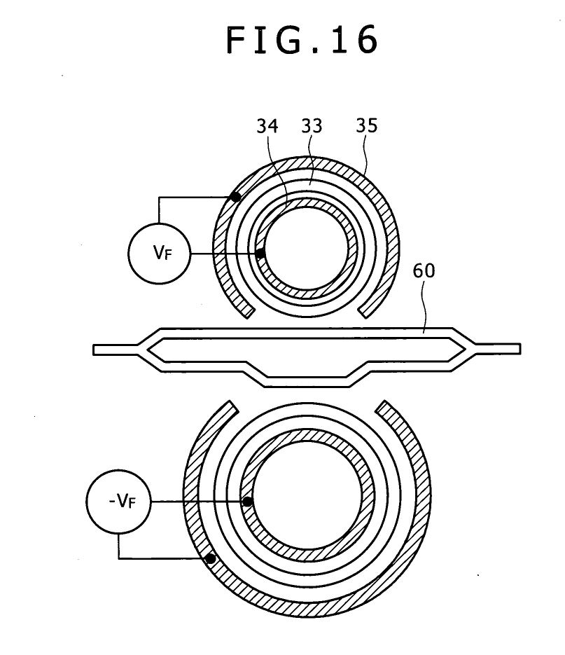

FIG. 16 shows an example of an asymmetrical MZ interferometer using a ring resonator according to the fourth embodiment, according to a sixth embodiment of the present invention. While a change in a loss peak is used to modulate the intensity of transmission light in the fourth embodiment, a change in a phase of light penetrating the ring resonator is used in the sixth embodiment. Since it is possible to more effectively cause a change in the phase by the effect of the ring resonator, as compared to a linear waveguide, it is possible to further reduce a drive voltage as compared to, for example, the general MZ interferometer disclosed in the third embodiment.

What is claimed is:

1. An optical device which includes at least a semiconductor waveguide formed on a semiconductor substrate in an extending direction of a surface of the substrate and changes a refractive index of the waveguide to control at least one of transmission amount of light, a light path, and a dispersion amount,
wherein a p-n junction is formed in the waveguide such that a junction interface exists in a normal direction to the surface of the substrate.

2. The optical device according to claim 1, wherein an electric field is applied to the p-n junction to change space charge in the waveguide, thereby causing a change in the refractive index and controlling penetrating light.

3. The optical device according to claim 1, wherein the waveguide has at least two p-n junctions.

4. The optical device according to claim 1, wherein the junction interface is provided in parallel with a light propagation direction of the waveguide.

5. The optical device according to claim 1, wherein the junction interface of the p-n junction is provided in a normal direction to an extending direction of the waveguide.

6. The optical device according to claim 1, wherein the junction interface of the p-n junction is provided in a direction which is perpendicular to a light propagation direction of the waveguide and is parallel with an extending direction of a cross section of the waveguide.

7. The optical device according to claim 1, wherein a semiconductor material of the waveguide uses silicon as a single constituent or uses silicon as a main constituent.

8. The optical device according to claim 1, wherein the device is an optical modulator or a variable light attenuator which changes an intensity of penetrating light, or an optical switch which changes a path of light, or a dispersion compensating device which controls a dispersion amount of penetrating light.

9. The optical device according to claim 1, wherein the device is a Mach-Zehnder optical interferometer, a ring resonator, or a directional coupler.
